(19) United States
(12) Patent Application Publication
(10) Pub. No.: US 2008/0243561 A1
(43) Pub. Date: Oct. 2, 2008

(54) Electronic mail based travel document check-in system

(75) Inventors: Mathias Deygout, Antibes (FR); Raphael Exartier, Grasse (FR); Christophe Tcheng, Valbonne (FR); Lou Sandholm, Nice (FR)

Correspondence Address: STEPTOE & JOHNSON LLP, 1330 CONNECTICUT AVENUE, N.W., WASHINGTON, DC, 20036, US

(73) Assignee: AMADEUS S.A.S.

(21) Appl. No.: 11/730,499

(22) Filed: Apr. 2, 2007

(51) Int. Cl. G06Q 50/00

(52) U.S. Cl. 705/5

(57) ABSTRACT

A system and method for a check-in procedure includes a reservation system, a customer loyalty system, and a self-service check-in system, which are connected to an e-mail capable device, for use by a customer, through an Internet or other public computer network. The self-service check-in system then sends a customer an e-mail notification, to which the customer can perform a check-in procedure by sending a reply e-mail. The self-service check-in system verifies the reply sent by the customer and sends the customer an e-mail confirmation that includes check-in information.

### FIELD OF THE INVENTION

The present invention relates to the field of computer travel management systems, and more particularly to an electronic system for allowing travel customers to check-in for a mode of transportation, such as a flight or sea cruise, or a hotel or other accommodation or event through an electronic e-mail.

### BACKGROUND OF THE INVENTION

Check-in is a procedure that a passenger undergoes when preparing to board a mode of transportation, such as a flight on an airline carriage by railroad or a voyage on an ocean going vessel. Check-in can occur for other events such as the acquisition of rental cars, hotels and resort accommodations, concerts or other performances, etc. Check-in is a process of confirming or affirming arrival for attendance of an event. While check-in usually takes place when a person is physically present at the site of the event or accommodation (such as hotel check-in), it may preceed arrival (such as advanced airline check in). Check-in often occurs after making an advance reservation.

With respect to air travel, check-in is usually the first procedure an airline passenger undertakes when arriving at an airport. During this process, the passenger has an ability to ask for special accommodations, such as seating preferences, inquire about flight or destination information, make changes to reservations, accumulate frequent-flyer miles, pay for upgrades if available or if allowed by the airline's upgrade policy, and otherwise make such adjustments as are available. In addition, the airline will confirm the identity of the traveling passengers, usually by checking the passengers' photo-identification. The check-in procedure is also a point in the travel process when a passenger may check luggage for the flight with the airline.

Some airlines offer kiosk check-in facilities where a passenger can check-in and acquire a boarding pass through the use of electronic terminal and means of identification, such as a credit card, or frequent flyer card. Passengers who only have carry-on luggage and use a check-in kiosk can then take their boarding pass and proceed to their departure gate. Passengers who have luggage to check for the flight still need the assistance of an agent.

An alternative means of checking-in is through a web portal. Typically within 24 hours of the flight departure time, passengers can check-in with the airline and select a seat, acquire a boarding pass, and specify any desired traveling parameters by going to that airline's web site, or the web site of the travel agency through which the passenger purchased the flight. Passengers who have only carry-on luggage can proceed directly to the departure gate once they have printed their boarding pass from the web portal. Passengers who need to check luggage still will have to leave their luggage with a desk agent. The use of a web portal requires that the passenger have access to a computer and communication network, such as the Internet.

A still further alternative means of checking-in available today is through a Short-Messaging-Service (SMS). SMS is a service available on most digital mobile phones (and other mobile devices, e.g. a Pocket PC, or occasionally even desktop computers) that permits the sending of short messages (also known as text messages, or more colloquially “SMSes”, “texts” or even “txts”) between mobile phones, other handheld devices and even landline telephones. Some airlines and travel agencies have check-in systems configured to enable check-in through the use of SMS.

### SUMMARY OF THE INVENTION

A system and method for a check-in procedure is disclosed herein. This system and method may be used to check-in prior to departure of a flight, a sea cruise, or other mode of transportation. This system and method may also be used to check-in for accommodations, such as a hotel, or any event that requires a check-in procedure.

The preferred system and method uses a reservation system and a customer loyalty system with a self-service check-in system. The check-in system is connected to an e-mail capable device for use by a customer through the Internet or other computer network.

The customer makes a reservation through the reservation system. This reservation may be for an airline flight, a train reservation, a sea cruise, a car rental, a sporting event, a hotel reservation, or some other form of transportation, accommodation, or event. The process of making the reservation includes acquiring an e-mail address for the customer and other customer information. This e-mail address and the other customer information are stored in the reservation system, the loyalty system or both. The loyalty system may already have the customer's e-mail address through a customer's reward program, or from a prior reservation.

At a specified time prior to the date when the thing for which the reservation was made is to occur, such as a flight departure, the self-service check-in system acquires the customers' e-mail from a Passenger Name Record (PNR) stored in the loyalty system or reservation system. The self-service check-in system then sends the customer an e-mail notification. The customer performs the check-in process by replying to the e-mail. This reply can take the form of sending a reply e-mail, which can include a type-written response listing customer preferences. These customer preferences can include, for example in combination with an airline flight, desired seat assignment, meal preference, or an indication of a special need such as a wheelchair attendant for assistance in boarding the aircraft.

The customer's reply is received by the self-service check-in system. The self-service check-in system verifies the reply sent by the customer. If the self-service check-in system is able to verify the reply, the self-service check-in system sends the customer an e-mail confirmation that can include, for example in the area of airline travel, a barcode together with a printable boarding card. Thus, through the use of e-mail, the customer was able to perform the check-in process.

Where multiple passengers are traveling as a group, it may be desirable to have a separate e-mail for each separate passenger for the e-mail check-in process described above. In the case where multiple passengers are traveling together, but not every passenger has an e-mail address, multiple passenger name records can be associated with a single e-mail address. In the case where multiple passenger name records are associated with a single e-mail address, the check-in procedure will occur as described above for the case where one passenger name record is associated with a single e-mail address, except that the replying to the single e-mail associated with multiple passenger name records will check in all of the passengers associated with that e-mail.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings listed below.

FIG. 1 depicts a block diagram of a check-in by e-mail system.

FIG. 2 depicts an exemplary screen display showing an e-mail sent by a self-service check-in system to initiate e-mail check-in.

FIG. 3 depicts an exemplary screen display showing an e-mail sent by a customer to a self-service check-in system to request check-in information.

FIG. 4 depicts an exemplary screen display showing an e-mail sent by a self-service check-in system to a customer having check-in information.

FIG. 5 depicts a flow diagram for an exemplary e-mail check-in process where one passenger name record is associated with a single e-mail account.

FIG. 6 depicts an exemplary customer loyalty database table used in conjunction with e-mail check-in.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

A system and method for a check-in procedure are disclosed herein. This system and method may be used to check-in prior to departure of a flight, a sea cruise, train ride, or other mode of transportation. This system and method may also be used to check-in for accommodations, such as a hotel, or any event that involves a check-in procedure.

The preferred system and method includes a reservation system, a customer loyalty system, and a self-service check-in system that is connected to an e-mail capable device for use by a customer through an Internet or other public computer network.

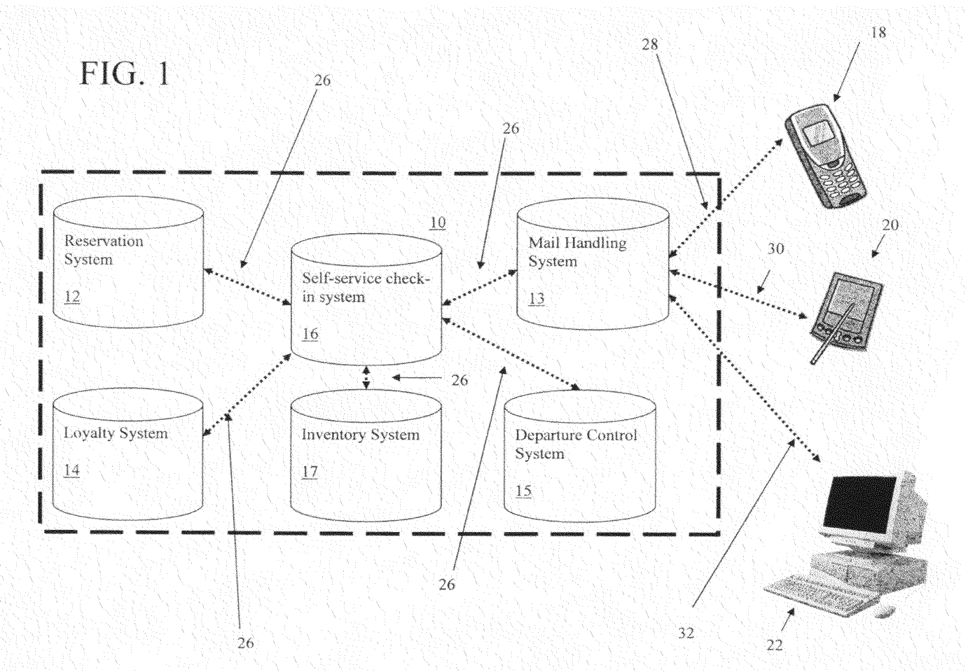

Referring to the Figures by characters of reference, FIG. 1 depicts a block diagram of a system 10 suitable for e-mail check-in. System 10 includes a reservation system 12, a mail handling system 13, a loyalty system 14, a departure control system 15, a self-service check-in system 16, and an inventory system 17. Self service check-in system 16 communicates with external devices, such as wireless phone 18, personal digital assistant 20, or a computer 22 through mail handling system 13. All components 12, 13, 14, 15, 16, and 17 within system 10 12 communicate with self-service check-in system 16 through another communications channel 26. An exemplary format of data exchange for channels 26 is EDIFACT (Electronic Data Interchange for Administration, Commerce and Transport). Self-service check-in system 16 communicates with devices 18, 20 and 22 through communications channels 28, 30 and 32 respectively. Mail handling system 13 is in charge of receiving, formatting and sending mails produced by system 16. Departure Control System (DCS) 15 supports all aspects of the interaction between the airline and its customers within the airport environment, as well as all aspects of the airlines' flight event planning and weight and balance functions. DCS 15 is in charge of the actual check-in with the airline for customers that use system 10 for check-in. Inventory system 17 signals when a reservation enters a period of time before the occurrence of the event that the reservation was made, for example 48 hours prior to departure of an airline flight. Inventory system 17 maintains inventory of all reservations made through system 10, for each date of operation, while ensuring optimized revenue on each reservation. Inventory system 17 maintains inventory of all reservations until flight departure and are then archived in a database, or erased.

Reservation system 12, loyalty system 14, and self-service check-in system 16 are computer based systems that include databases of customer information and are capable of communicating over channels 26. System 10 communicates with devices 18, 20 and 22 by through various means such as a wireless communications network or the Internet. An exemplary embodiment for reservation system 12 is Amadeus Altea Reservation. An exemplary embodiment for inventory system 17 is Amadeus Altea Inventory. An exemplary embodiment for departure control system 15 is Amadeus Altea Departure Control. An exemplary embodiment of mail handling system 13 is a coupling of Amadeus System Integrator for the format conversion to EDIFACT and Amadeus Messenger Server for receiving and sending e-mails and for mail session handling.

Devices 18, 20 and 22 are all configured to send and receive electronic mail messages, conventionally referred to as “e-mail.”

System 10 allows customers to check-in for an event through devices 18, 20 and 22. Once the customers are checked-in, system 10 provides the customers with the boarding pass ticket or other confirmation for the event. The term “event” here includes, but is not limited to a flight for a commercial airline, a sea cruise, a car rental, a sporting or cultural event, a train trip, a hotel accommodation, or other form of transportation, event, or accommodation.

Reservation system 12 stores reservation information. The reservation information typically includes customer information and event information. The customer information typically includes the name, mailing address, telephone number, customer preference information, and payment information of a customer. The customer information may also include an e-mail address for the customer. In the case of an airline flight, the event information typically includes the date of the flight, the flight number, the airline, the origination and destination cities, seat preferences, meal preferences, emergency contact information, and possibly other information.

Loyalty system 14 stores a database of customer loyalty information in support of a customer loyalty program. The customer loyalty information can include some or all of the customer information in the reservation system, along with loyalty information such as the time the customer has been a part of the program, the number of miles they have accumulated points or cash-back awards that the customer as acquired in the program (such as through use of a travel card), preferences of the customer gathered through the program, and other loyalty information. In the case of air travel, loyalty system 14 may support a frequent flyer miles program.

Once a customer has made a reservation for an event such as a flight that is stored in reservation system 12, the customer may need to “check-in” within a specified period of time prior to that event. Self-service check-in system 16 is configured to send an e-mail to the customer's e-mail account through system 13, which they can access through devices 18, 20 and 22. While FIG. 1 illustrates a wireless phone, a PDA, and a computer, any device through which a customer can receive, access and send e-mail may be used with system 10. Self-service check-in system 16 sends an e-mail to the customer at a predetermined amount of time prior to the event for which the customer made a reservation is about to occur. For a flight reservation, self-service check-in system 16 could, for example, send an e-mail to the customer 24 hours prior to the departure time of the flight, which is typically the maximum time an airline will allow a customer to check-in prior to a flight.

Once the customer receives the e-mail through their device 18, 20 or 22, the customer can perform the check-in process by responding to the e-mail. A customer my reply to this e-mail simply by sending a reply e-mail to system 13 from their e-mail account. This reply e-mail is typically created by selecting a “reply” option from their e-mail account and selecting the “send” option. This reply can include a type-written response listing customer preferences. These customer preferences can include, for example in combination with an airline flight, desired seat assignment, meal preference, or an indication of a special need such as a wheel chair attendant for assistance in boarding the aircraft.

Self-service check-in system 16 may acquire the customer's e-mail address from the reservation record stored in reservation system 12, or it may acquire the e-mail address from the customer's loyalty record stored in loyalty system 14. Many customers have more than one e-mail address. Self-service check-in system 16 may send an initial e-mail and a subsequent e-mail containing the check-in information to some or all e-mail addresses associated with that customer in either the reservation system 12 or loyalty system 14. Check-in system 16 may determine which of the plurality of customer e-mails to send to based on either customer preferences or other communication information, such as e-mail addresses that are no-longer active or servers that return e-mails as undeliverable.

System 13 supports system 16 with processing the check-in information received in the customer email. System 10 then communicates this check-in information to the airlines through departure control system 15.

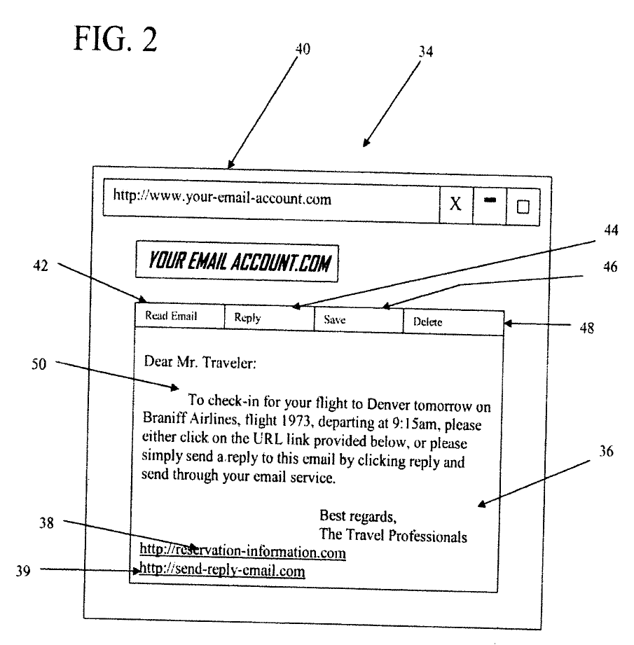

FIG. 2 depicts an exemplary screen display 34 showing an e-mail 36 for e-mail check-in through self-service check-in system 16. Screen display 34 illustrates a conventional WINDOWS™ environment browser for accessing the Internet through a web address 40 though other e-mail viewing environments may be used. In this example, the web address is for the customer's e-mail service “www.your-e-mail-account.com.” The customer is able to read e-mail 36 by selecting a “read e-mail” button 42. The customer may reply to e-mail 36 with “reply” button 44. The customer may save e-mail 36 with “Save” button 46. The customer may also delete e-mail 36 with “Delete” button 48. The text of e-mail 36 instructs the customer on how to reply to the e-mail so that self-service check-in system can process the check-in and send the check-in information back to the customer through a second e-mail. This reply may take the form of a reply e-mail produced by selecting “Reply” button 44 and selecting a “Send” button to send that e-mail back to self-service check-in system 16. This reply can include a type-written response listing customer preferences. These customer preferences can include, for example in combination with an airline flight, desired seat assignment, meal preference, or an indication of a special need such as a wheel chair attendant for assistance in boarding the aircraft. Link 38 allows the customer to access current information regarding their reservation from a web site supported by self-service check-in system 16. The web site may also allow a customer to use an on-line, web based check-in system. Alternatively, the customer may spawn a reply email by selecting browser link 39.

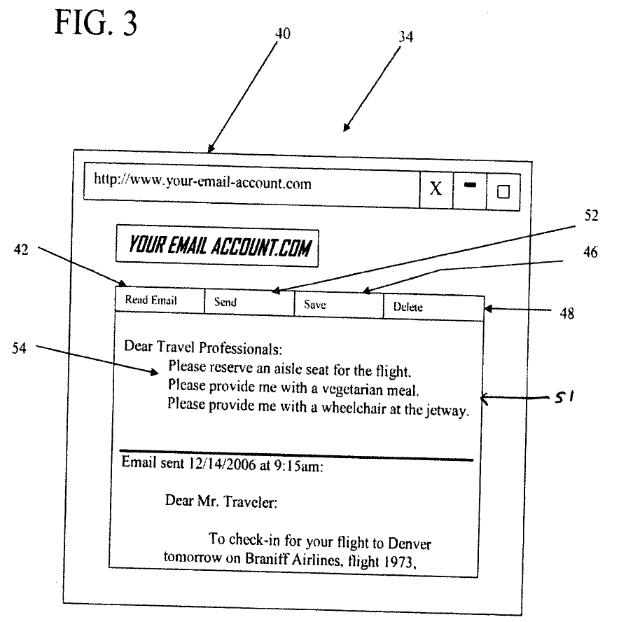

FIG. 3 depicts an exemplary screen display showing an e-mail 51 sent by a customer to a self-service check-in system 16 to request check-in information. E-mail 51 is sent by a customer to self-service check-in system 16 in response to the e-mail shown in FIG. 2. E-mail 51 includes customer preference information 54. This customer preference information is exemplary for a flight, in which case the customer is a passenger who is requesting an aisle seat, a vegetarian meal, and a wheelchair for use at the jetway. This list of preferences is merely exemplary. In the case where the customer is checking-in for a sea-voyage, a hotel, or an event, the list of preferences may include other preference information. The self-service check-in system 16 takes this preference information and processes the request in order to provide the customer with as many of their preferences as possible. The customer sends e-mail 54 to self-service check-in system 16 by means of send button 52. Mail handling system 13 receives e-mail 54. The check-in information included in e-mail 54 is then processed by mail handling system 13. Mail handling system 13 may discern the check-in information through parsing the first word of the answer to determine if the check-in proposal has been accepted or rejected by searching, for example in English, for “yes,” “no,” “y,” or “n.” Mail handling system 13 may also utilize a semi-natural language process to parse the e-mail for further check-in information, such as, for example, searching for the words “aisle,” “window,” “vegetarian,” “wheelchair,” or other relevant keywords pertaining to the reservation.

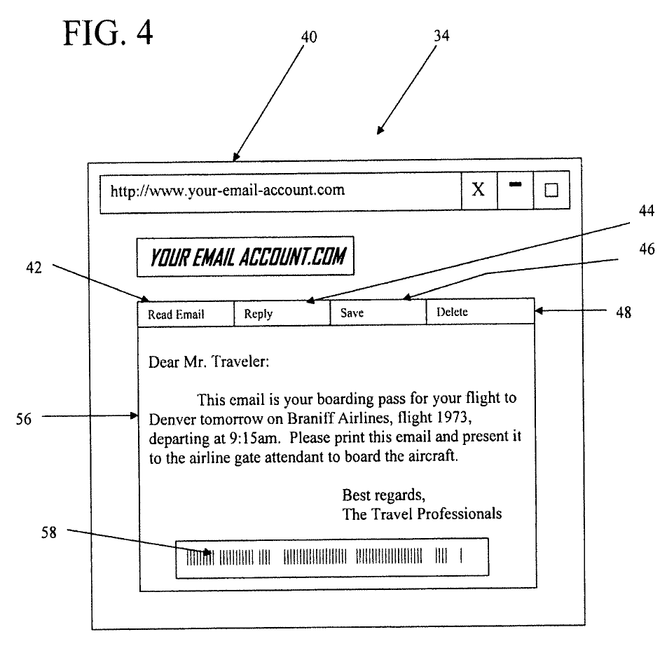

FIG. 4 depicts an exemplary screen display showing an e-mail 56 sent by a self-service check-in system 16 to a customer. Once self-service check-in system has received e-mail 51 in FIG. 3 from the customer and has processed the customer's list of preferences, self-service check-in system 16 sends the customer e-mail 56, which includes check-in information 58. In this example, e-mail 56 is a printable boarding-pass for an airline reservation and information 58 is a scanable bar code that a gate attendant can scan and verify. Other check-in information can include flight information changes, updates on the customer's list of preference requests sent in e-mail 51, or other check-in information appropriate to the form of transportation, accommodation, or other event that the customer has reserved.

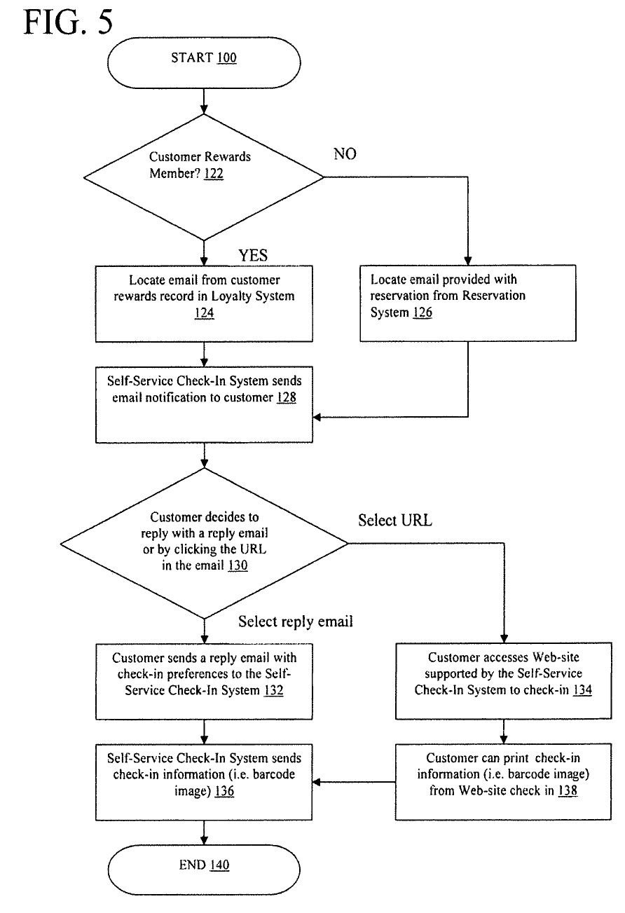

FIG. 5 depicts a flow diagram for an exemplary e-mail check-in process. The process begins at START 100. Self-service check-in system 16 determines in step 122 if the customer is a member of a loyalty program. If the customer is a member of a loyalty program, self-service check-in system 16 seeks the customer's e-mail address in loyalty system 14 in step 124. Alternatively, in step 126, if the customer is not a member of a loyalty program, self-service check-in system 16 seeks for the customer's e-mail address in the customer information record stored in reservation system 12. Then, in step 128, self-service check-in system 16 sends an e-mail notification to the customer. In step 130, the customer decides to answer the e-mail either with a replay email or by clicking URL 38 or 39. In step 132 where the customer replies with an e-mail that is received by mail handling system 13. In step 136, self-service check-in system 16 receives the customer's e-mail and replies with a second e-mail via system 13 that includes the check-in information, such as a boarding pass in the case of an airline flight. The process concludes with END in step 140. Alternatively, the customer could have accessed a web-site supported by self-service check-in system via links 38 or 39 in step 134. From that web-site, the customer may perform check-in and print their check-in information, such as a boarding pass in step 138. The process then similarly concludes with END in step 140. In the event that customer elects not to check-in via e-mail check-in system 10, e-mail check-in system 10 will take no action and the customer will have to check-in through alternative conventional means such as via telephone, the internet, a travel agent, or at the airport. The customer may elect to not use the check-in system by either not sending e-mail 54 or by stating in e-mail 54 that they do not wish to check-in.

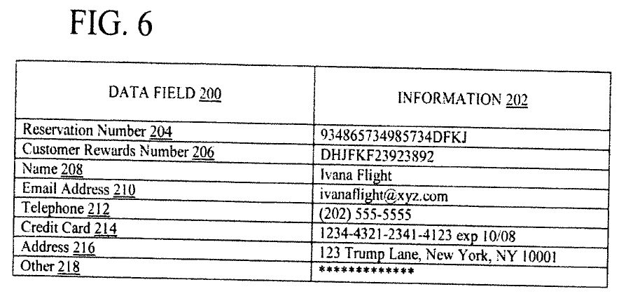

FIG. 6 depicts an exemplary customer record that may be located in either the loyalty database stored in loyalty system 14 or in a reservation record stored in reservation system 12. The customer record includes data fields 200 and corresponding data 202. Data fields 200 include reservation number 204, customer rewards number 206, the customer's name 208, at least one customer e-mail address 210, a telephone number 212, credit card information 214, address 216, and possibly other information 218.

The various techniques, methods, and systems described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those described elsewhere in this document. Various computer-based systems, methods and implementations in accordance with the above-described technology are presented below.

In one implementation, a general-purpose computer may have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs may be installed on the internal or external storage of the general-purpose computer. Alternatively, in another implementation, application programs may be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

The general-purpose computer may include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices may themselves include the functionality of the general-purpose computer. For example, the mobile phone or the PDA may include computing and networking capabilities and function as a general purpose computer by accessing the delivery network and communicating with other computer systems. Examples of a delivery network include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link may include communication pathways that enable communications through one or more delivery networks.

In one implementation, a processor-based system (e.g., a general-purpose computer) can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. A removable storage medium can include a floppy disk, magnetic tape, optical disk, etc., which can be removed from the storage drive used to perform read and write operations. As will be appreciated, the removable storage medium can include computer software and/or data.

In alternative embodiments, the secondary memory may include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, the computer system can also include a communications interface that allows software and data to be transferred between computer system and external devices. Examples of communications interfaces can include a modem, a network interface (such as, for example, an Ethernet card), a communications port, and a PCMCIA slot and card. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer usable medium” are generally used to refer to media such as a removable storage device, a disk capable of installation in a disk drive, and signals on a channel. These computer program products provide software or program instructions to a computer system.

Computer programs (also called computer control logic) are stored in the main memory and/or secondary memory. Computer programs can also be received via a communications interface. Such computer programs, when executed, enable the computer system to perform the features as discussed herein. In particular, the computer programs, when executed, enable the processor to perform the described techniques. Accordingly, such computer programs represent controllers of the computer system.

In an embodiment where the elements are implemented using software, the software may be stored in, or transmitted via, a computer program product and loaded into a computer system using, for example, a removable storage drive, hard drive or communications interface. The control logic (software), when executed by the processor, causes the processor to perform the functions of the techniques described herein.

In another embodiment, the elements are implemented primarily in hardware using, for example, hardware components such as PAL (Programmable Array Logic) devices, application specific integrated circuits (ASICs), or other suitable hardware components. Implementation of a hardware state machine so as to perform the functions described herein will be apparent to a person skilled in the relevant art(s). In yet another embodiment, elements are implanted using a combination of both hardware and software.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol (HTTP)). The selected page is then displayed to the user on the client's display screen. The client may then cause the server containing a computer program to launch an application to, for example, perform an analysis according to the described techniques. In another implementation, the server may download an application to be run on the client to perform an analysis according to the described techniques.

Although the present invention has been described in detail, it will be apparent to those of skill in the art that the invention may be embodied in a variety of specific forms and that various changes, substitutions, and alterations can be made without departing from the spirit and scope of the invention. The described embodiments are only illustrative and not restrictive and the scope of the invention is, therefore, indicated by the following claims.

What is claimed is:

1. A method for a passenger to check-in for a scheduled travel accommodation, comprising:
sending a first electronic-mail message from a check-in system to an e-mail address associated with a traveler in advance of the time of the scheduled travel accommodation, said first electronic mail message identifying the passenger and the travel accommodation;
receiving at the check-in system a second electronic-mail message affirming the traveler's arrival for the accommodation; and
in response to the second electronic-mail message, sending a third electronic-mail from the check-in system to an email address associated with the traveler, said third electronic-mail message confirming the traveler's scheduled travel accommodation.

2. The method of claim 1, wherein the check-in information comprises a printable boarding-pass.

3. The method of claim 1, wherein the check-in information comprises an electronic boarding-pass.

4. The method of claim 1, wherein the second electronic-mail comprises passenger-preference information.

5. The method of claim 4, wherein the passenger-preference information comprises a flight seat selection.

6. The method of claim 4, wherein the passenger-preference information comprises a flight meal selection.

7. The method of claim 4, wherein the passenger-preference information comprises a request for handicapped assistance.

8. The method of claim 1, further comprising determining whether the passenger is a member of an airline loyalty program.

9. The method of claim 1, further comprising acquiring an electronic-mail address for the passenger from a reservation record stored in a reservation system.

10. The method of claim 8, further comprising acquiring an electronic-mail address for the passenger from a reservation record stored in a reservation system when the passenger is not a member of the airline loyalty program.

11. The method of claim 8, further comprising acquiring an electronic-mail address for the passenger from a customer record stored in a loyalty system when the passenger is a member of the airline loyalty program.

12. The method of claim 1, further comprising receiving the first and third electronic-mails with a computer.

13. The method of claim 1, further comprising receiving the first and third electronic-mails with a wireless device.

14. The method of claim 1, wherein the first electronic mail comprises flight departure information.

15. The method of claim 1, further comprising associating multiple passengers with a single electronic-mail address, the first electronic-mail comprising flight departure information for each of the multiple passengers, the third electronic-mail comprising check-in information for each of the multiple passengers.

16. A method for performing a check-in process prior to an event that requires a check-in process, comprising:
sending a first electronic-mail to an event-participant a predetermined amount of time prior to the occurrence of the event that the event-participant is to participate in;
receiving a second electronic-mail from the event-participant in response to the first electronic-mail; and
sending a third electronic-mail to the event-participant in response to the second electronic-mail, the third electronic-mail having check-in information.

17. The method of claim 16, wherein the check-in information comprises a printable ticket.

18. The method of claim 16, wherein the check-in information comprises an electronic ticket.

19. The method of claim 16, wherein the second electronic-mail comprises event-participant preference information.

20. The method of claim 19, wherein the event-participant preference information comprises airline travel information.

21. The method of claim 19, wherein the event-participant preference information comprises a passenger information related to an ocean voyage.

22. The method of claim 19, wherein the event-participant preference information comprises car rental information.

23. The method of claim 16, further comprising determining whether the event-participant is a member of a company loyalty program.

24. The method of claim 16, further comprising acquiring an electronic-mail address for the event-participant from a reservation record stored in a reservation system.

25. The method of claim 23, further comprising acquiring an electronic-mail address for the event-participant from a reservation record stored in a reservation system when the event-participant is not a member of the company loyalty program.

26. The method of claim 23, further comprising acquiring an electronic-mail address for the event-participant from a customer record stored in a loyalty system when the event-participant is a member of the company loyalty program.

27. The method of claim 1, further comprising receiving the first and third electronic-mails with a computer.

28. The method of claim 1, further comprising receiving the first and third electronic-mails with a wireless device.

29. The method of claim 1, wherein the first electronic mail comprises event information.

30. The method of claim 1, further comprising associating multiple event participants with a single electronic-mail address, the first electronic-mail comprising event information for each of the multiple event-participants, the third electronic-mail comprising check-in information for each of the multiple event-participants.

31. A sequence of electronic-messages transmitted during a check-in process, comprising:
a first electronic message sent from a self-service check-in system to a customer having an electronic-mail capable device, the first electronic message comprising an invitation to check-in prior to an event by responding to the first electronic message;
a second electronic message sent from the electronic-mail capable device to the self-service check-in system;
a third electronic message sent from the self-service check-in system to the electronic-mail capable device, the third electronic message comprising check-in information.

32. The sequence of electronic-messages of claim 31, wherein multiple customers are associated with a single electronic-mail address, the first electronic-mail comprising an invitation to check-in for each of the multiple customers, the third electronic-mail comprising check-in information for each of the multiple customers.
